(19) United States
(12) Patent Application Publication
(10) Pub. No.: US 2009/0032790 A1
(43) Pub. Date: Feb. 5, 2009

(54) Portable electric fence

(76) Inventor: Broadus F. Timms, Hodges, SC (US)

Correspondence Address: J. BENNETT MULLINAX, LLC, P. O. BOX 26029, GREENVILLE, SC, 29616-1029, US

(21) Appl. No.: 11/890,052

(22) Filed: Aug. 3, 2007

(51) Int. Cl. H05C 1/02; E04H 17/16

(52) U.S. Cl. 256/25; 256/24; 256/10

(57) ABSTRACT

An electric fence is provided. The electric fence includes a plurality of panels that are releasably connected to one another to form at least a partial enclosure. Each of the panels has a frame that includes a top horizontal member, a bottom horizontal member, and two side vertical members. The panels are arranged side by side such that the vertical members of adjacent panels are releasably connected to one another. The frame carries a wire member that is electrically conductive for use in delivering an electrical shock to livestock that comes into contact with the wire member.

### FIELD OF THE INVENTION

The present invention relates generally to an electric fence used in containing livestock. More particularly, the present application involves an electric fence made of a plurality of panels that can be assembled and disassembled in order to construct temporary enclosures.

### BACKGROUND

Electric fences generally employ a bare wire through which electricity may be conducted for purposes of imparting an electrical shock to the person or animal touching the bare wire. In this regard, voltage in the wire is conducted through the person or animal touching the wire and into the ground to cause a painful shock and thus discourage movement across the electric fence. An electric fence may therefore be used to keep livestock contained within a desired area and may at the same time be used to prevent predatory animals from gaining access to the livestock. Electric fencing enjoys cost advantages over other types of fences in that a large physical barrier to prevent crossing does not have to be constructed. Additionally, electric fencing causes less damage to people and animals than other types of fencing such as those employing barbed wire.

One aspect of dairy farming, beef production, or any other type of ranching operation that includes pastures is the desire to move the animals from one area to the other. This movement contributes towards obtaining maximum production from the program, extends the life of the pasture, reduces the amount of compaction and trampling of the soil, and prevents animal waste from building up in a particular section of ground. Movement of livestock between multiple, smaller areas is known as rotational grazing. Stationary electric fencing is sometimes used to divide a pasture up into multiple smaller areas. However, the construction of stationary electric fencing requires a large amount of work, wire and equipment in building the numerous amount of fencing.

A portable electric fence is known that incorporates a plurality of wheels that support a bare wire used in delivering a shock to the livestock upon contact. The portable electric fence is stretched out between parallel stationary fence rows. Winches are located on either end of the portable electric fence in order to take up slack in the bare wire. Skids on either end of the portable fence can be moved with a tractor in order to change the position of the portable fence for purposes of modifying the area to which the livestock has access. Although this arrangement provides an electric fence with some degree of mobility, it requires the presence of stationary fence rows and only allows for the construction of fencing enclosures of limited shapes. As such, there remains room for variation and improvement within the art.

### SUMMARY

Various features and advantages of the invention will be set forth in part in the following description, or may be obvious from the description, or may be learned from practice of the invention.

One aspect of one exemplary embodiment includes an electric fence that has a plurality of panels that are releasably connected to one another to form at least a partial enclosure. Each of the panels has a frame that includes a top horizontal member, a bottom horizontal member, and two side vertical members. The panels are arranged side by side such that the vertical members of adjacent panels are releasably connected to one another. The frame carries a wire member that is electrically conductive for use in delivering an electrical shock to livestock that comes into contact with the wire member.

Another aspect of an additional embodiment resides in an electric fence as immediately mentioned in which the wire member is a mesh that covers an area defined by the top horizontal member, the bottom horizontal member and the two side vertical members.

An additional aspect of an exemplary embodiment is present in an electric fence as described above in which the frame has at least two legs that suspend the bottom horizontal member at least one foot off of the ground.

A further aspect of an additional exemplary embodiment resides in an electric fence as previously mentioned in which the wire member is attached to the top horizontal member with an electrically conductive upper attachment member. The wire member is attached to the bottom horizontal member with an electrically conductive lower attachment member.

Another aspect of an additional exemplary embodiment is found in an electric fence as previously mentioned in which the top horizontal member, bottom horizontal member and two side vertical members are nonconductive and are made of polyvinyl chloride tubing.

One aspect of one exemplary embodiment includes a panel for use in an electric fence that has a frame made of a generally nonconductive material. A wire member is carried by the frame and is configured for conducting electricity therethrough for use in delivering an electric shock to livestock that comes into contact with the wire member. The wire member is configured for being in electrical communication with a second wire member of an adjacent second panel so that electricity is capable of being conducted through the wire member and into the second wire member.

Another aspect of a further exemplary embodiment involves a panel as immediately mentioned in which the frame has a plurality of legs configured for contacting the ground of a pasture so that the legs are capable of standing on the ground and are not driven into the ground. The legs are configured to elevate the wire member at least six inches from the ground of the pasture.

One aspect of one exemplary embodiment involves a panel as previously mentioned in which the frame has a top horizontal member, a bottom horizontal member, and two side vertical members. The wire member is attached to the top horizontal member with an electrically conductive upper attachment member that is a wire that is wrapped around the top horizontal member. The wire member is attached to the bottom horizontal member with an electrically conductive lower attachment member that is a wire that is wrapped around the bottom horizontal member.

Another aspect of yet another exemplary embodiment is provided in a panel as mentioned prior in which the frame is made of polyvinyl chloride tubing.

A further aspect of another exemplary embodiment exists in a panel as set forth above in which the wire member is a mesh that spans the distance from one side of the frame to an opposite side of the frame.

One aspect of one exemplary embodiment includes a panel for use in an electric fence that has a frame. The frame has a top horizontal member, a bottom horizontal member, and two side vertical members arranged in a generally rectangular shape. The top horizontal member, bottom horizontal member, and two side vertical members are made of a generally nonconductive material. A wire member, that is a mesh, is carried by the frame. The wire member covers an area defined by the top horizontal member, bottom horizontal member, and two side vertical members. The wire member is electrically conductive. At least two legs are configured for contacting and resting on the surface of the ground of a pasture and for elevating the frame and wire member above the surface of the ground of the pasture. A releasable connection is capable of engaging the frame in order to releasably connect the frame to a second frame of a second panel.

Another aspect of an additional exemplary embodiment involves a panel as immediately discussed in which the top horizontal member, bottom horizontal member, two side vertical members, and two legs are made of polyvinyl chloride tubing. The wire member is attached to the top horizontal member with an electrically conductive upper attachment member that is a wire that is wrapped around the top horizontal member. The wire member is attached to the bottom horizontal member with an electrically conductive lower attachment member that is a wire that is wrapped around the bottom horizontal member.

These and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended Figs. in which:

FIG. 1 is a perspective view of an electric fence composed of a number of panels in accordance with one exemplary embodiment.

FIG. 2 is a front view of two panels in accordance with one exemplary embodiment.

FIG. 3 is cross-sectional view taken along line 3-3 of FIG. 2.

FIG. 4 is a detailed front view of two panels showing their electrical and physical connection via coil springs in accordance with one exemplary embodiment.

FIG. 5 is a cross-sectional view of a releasable connection that is a sleeve in accordance with one exemplary embodiment.

FIG. 6 is a front view of the sleeve of FIG. 5.

FIG. 7 is a detailed front view of two panels showing their physical connection via a pair of sleeves in accordance with one exemplary embodiment.

Repeat use of reference characters in the present specification and drawings is intended to represent the same or analogous features or elements of the invention.

### DETAILED DESCRIPTION OF REPRESENTATIVE EMBODIMENTS

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

It is to be understood that the ranges mentioned herein include all ranges located within the prescribed range. As such, all ranges mentioned herein include all sub-ranges included in the mentioned ranges. For instance, a range from 100-200 also includes ranges from 110-150, 170-190, and 153-162. Further, all limits mentioned herein include all other limits included in the mentioned limits. For instance, a limit of up to 7 also includes a limit of up to 5, up to 3, and up to 4.5.

The present invention provides for an electric fence 10 that can be used to contain livestock 38 in a particular area of a pasture. The electric fence 10 can be portable so that it may be moved or reconfigured in a relatively fast and easy manner in order to contain the livestock 38 in a different section of the pasture when rotational grazing is desired. Alternatively or additionally, the electric fence 10 can be used to form a complete or partial enclosure for a number of different uses besides or in addition to rotational grazing. The electric fence 10 includes a plurality of panels 12 that can be arranged next to one another in order to form a barrier of a desired shape and configuration. The panels 12 each include a wire member 26 that is electrified in order to deliver a shock to the animal upon contact so that the animal will not traverse the electric fence 10.

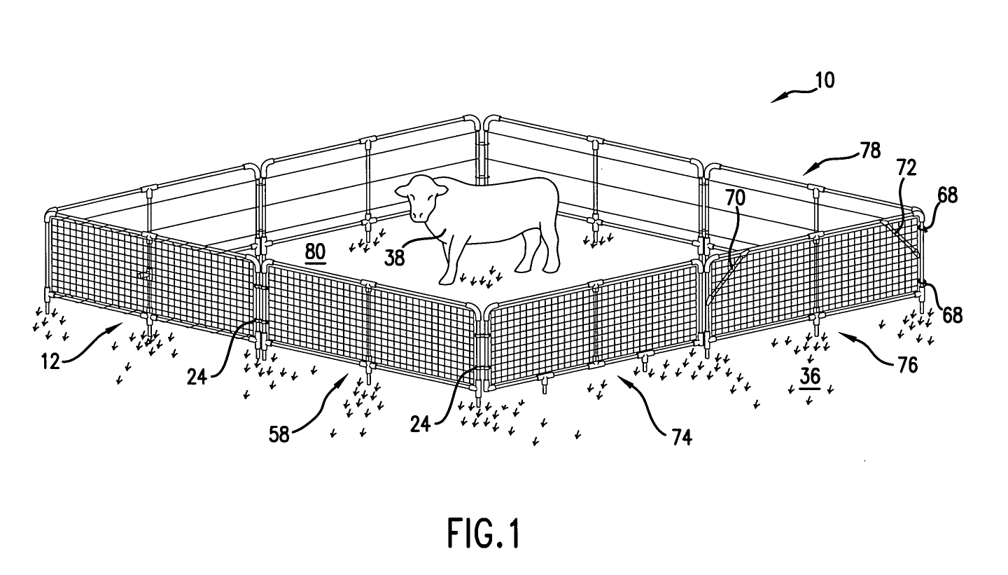

An electric fence 10 in accordance with one exemplary embodiment is shown in FIG. 1. The electric fence 10 is present in a pasture and forms an enclosure 80 for holding livestock 38 in a desired area of the pasture. The electric fence 10 is made of a plurality of panels 12 that allow the electric fence 10 to be formed over pastures of various topographies and to form enclosures 80 of different sizes and shapes. Although shown as completely forming a contained enclosure 80, it is to be understood that the electric fence 10 need not form a completely contained enclosure 80 in accordance with other exemplary embodiments. For example, the electric fence 10 may form part of the enclosure 80 while other objects such as a barn, stream, split rail fence, hillside or other structure forms the other portions of the enclosure 80. Also, in accordance with other embodiments an enclosure 80 need not be formed. For example, the electric fence 10 can be arranged so that it forms a wall that runs a desired length that is open on both ends.

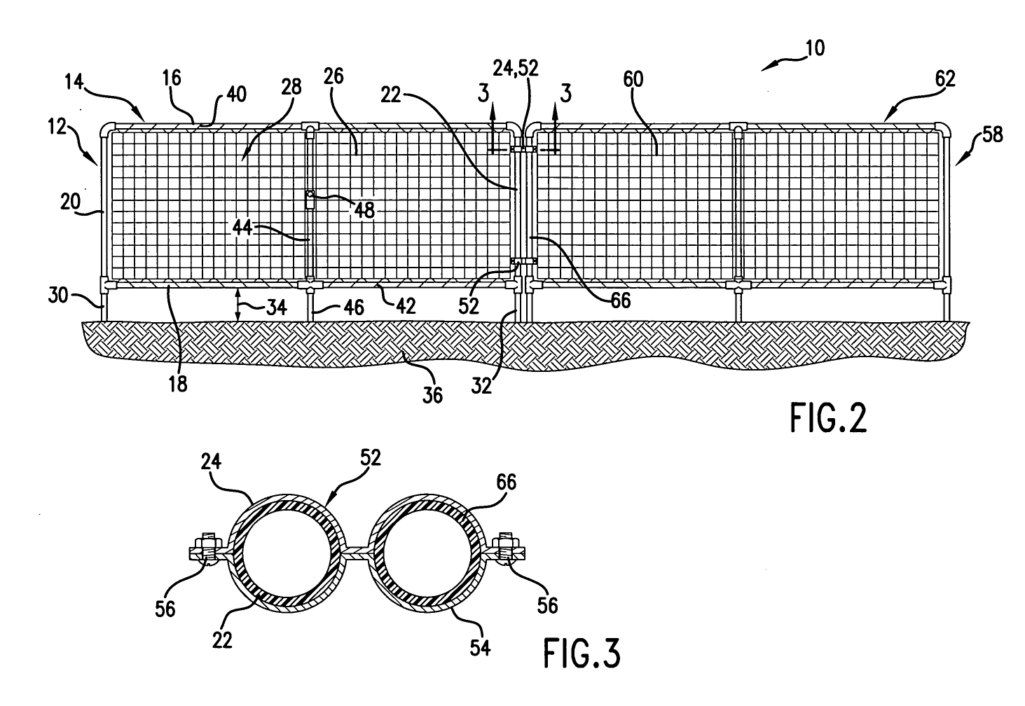

FIG. 2 is a front view of an electric fence 10 in accordance with one exemplary embodiment. The electric fence 10 includes a panel 12 that has a frame 14 that carries the wire member 26. Frame 14 can be constructed in a variety of different manners. As shown, frame 14 is made out of polyvinyl chloride tubing. In accordance with other exemplary embodiments the frame 14 can be made out of wood, plastic, a composite material or metal. The frame 14 may be generally electrically nonconductive or may be electrically conductive in various embodiments. The frame 14 can be treated with a UV resistant material or may be made out of polyvinyl chloride that is resistant to UV rays as the panel 12 will generally remain outdoors and exposed to sunlight during times of use and times when the panel 12 is not in use as an electric fence 10.

The frame 14 includes a top horizontal member 16 and a bottom horizontal member 18 that are oriented parallel to one another. A pair of side vertical members 20 and 22 can be located on opposite ends of the horizontal members 16 and 18 in order to define an area 28 that has a generally rectangular perimeter. The side vertical members 20 and 22 may thus be parallel with one another and can form right angles with the top and bottom horizontal members 16 and 18 as shown in FIG. 2. The top horizontal member 16, bottom horizontal member 18 and side vertical members 20 and 22 may be connected to one another through the use of fittings such at T-fittings and elbows. However, the members 16, 18, 20 and 22 may be welded, bolted or connected through adhesives in accordance with other embodiments. Further, it is to be understood that the members 16, 18, 20 and 22 may be integrally formed with one another so that the frame 14 is made of a single piece in certain embodiments. Also, the members 16, 18, 20 and/or 22 need not be present in other exemplary embodiments. For example, the frame 14 may be made of a single, molded component that does not have an open center but instead has a solid face. In this regard, an open frame 14 may be more desirable as it will allow one to view through the panel 12 in order to observe livestock 38. However, it is to be understood that a closed frame 14 can be used in other embodiments if desired. Additionally, the frame 14 need not be rectangular in shape but may instead be made in a variety of shapes. For example, the frame 14 can be circular, square, oval or irregular in shape in accordance with other embodiments. The frame 14 can be made by any suitable process. For example, injection molding may be used in order to construct frame 14.

The frame 14 carries a wire member 26 that is used in imparting an electrical shock to livestock 38 in order to prevent the livestock 38 from moving past the panel 12. The wire member 26 is electrically conductive and can be made out a variety of materials. For example, the wire member 26 may be made out of steel, iron or aluminum in certain embodiments. The wire member 26 may be a mesh that covers the area 28 that is defined by the members 16, 18, 20 and 22. The wire member 26 may be made out of mesh that is four inches by four inches in one embodiment.

The wire member 26 may be attached to the frame 14 in a variety of manners. As shown, an upper attachment member 40 is used to attach the wire member 26 to the top horizontal member 16. The upper attachment member 40 can be wire that is located through the wire member 26 and wrapped around the upper attachment member 40 to effect attachment. Electricity conducted through the wire member 26 can be transferred into the upper attachment member 40 so that this component is likewise electrically conductive and will shock livestock 38 upon contact. As such, the upper attachment member 40 can prevent livestock 38 or other animals from moving over the top horizontal member 16. The wire member 26 is likewise attached to the bottom horizontal member 18. In this regard, a lower attachment member 42 is located through the wire member 26 and loops around the bottom horizontal member 18 to effect attachment. The lower attachment member 42 is shown as wire and can be electrically conductive so that electricity in the wire member 26 can be transferred into the lower attachment member 42 and prevent livestock 38 or other animals from moving under the bottom horizontal member 18.

In the exemplary embodiment shown, the wire member 26 is not attached to the side vertical members 20 and 22. However, it is to be understood that other exemplary embodiments are possible in which the wire member 26 can be attached to any number of or portion of the various components making up the frame 14. For example, the wire member 26 may be attached to the side vertical members 20 and 22 and not to either the top horizontal member 16 or the bottom horizontal member 18. In other embodiments, the upper and lower attachment members 40 and 42 need not be present. For example, the wire member 26 may be molded into the frame 14 or may simply rest inside of a recess of the frame 14 in order to be retained thereon. Further, the upper and lower attachment members 40 and 42 need not be wire in other exemplary embodiments. For example, the members 40 and 42 may be springs, string, bolts, adhesive or mechanical fasteners. Also, the upper and lower attachment members 40 and 42 need not be electrically conductive in other versions of the panel 12. Likewise, although described as receiving electricity from the wire member 26, the upper and/or lower attachment members 40, 42 may instead transfer electricity into the wire member 26 in other arrangements.

The frame 14 includes a pair of legs 30 and 32 that function to hold the bottom horizontal member 18 a distance 34 from the ground 36 of the pasture. The legs 30 and 32 can be made of the same material as the rest of the members 16, 18, 20 and 22 of frame 14 or may be made of a different material. The legs 30 and 32 may be generally electrically nonconductive so that electricity in the wire member 26 or other components of the frame 14 is not transferred into the ground 36. The legs 30 and 32 may be separate components that are attached to the bottom horizontal member 18 and the side vertical members 20 and 22 through the use of T-fittings. Other attachment mechanisms are possible in accordance with other exemplary embodiments. Further, the legs 30 and 32 may be integrally formed with the side vertical members 20 and 22 so that the side vertical member 20 and leg 30 are a single integral piece and so that the side vertical member 22 and leg 32 are likewise a single integral component.

Distance 34 may be from three inches to twenty four inches in accordance with certain exemplary embodiments. The frame 14 may be variously sized. For instance, the distance 34 may be one foot, the side vertical members may be four feet in length and the top and bottom horizontal members 16 and 18 may be ten feet in length. The distance 34 may be proportioned with respect to the length of side vertical members 20 and 22 so that the side vertical members 20 and 22 are four times, five times, or up to ten times the length of the distance 34. The provision of distance 34 functions to keep the wire member 26 out of contact with ground 36 and allows the panel 12 to be positioned on ground 36 that has hills or valleys. The legs 30 and 32 can rest on top of the ground 36 so that they are not driven into the ground 36 in order to retain the panel 12. The bottom of legs 30 and 32 may be capped or may be open and can rest on the top of ground 36. Alternative arrangements are possible, however, in which the legs 30 and 32 may be driven into ground 36. Also, it is to be understood that the panel 12 may be constructed so that the legs 30 and 32 are not present. In these embodiments, the bottom horizontal member 18 may contact the top of ground 36.

The frame 14 as shown in FIG. 2 also includes a middle vertical member 44. The middle vertical member 44 can be made of the same material and shaped in the same manner as the other components of frame 14 or may be uniquely configured. For example, the middle vertical member 44 can be made out of polyvinyl chloride tubing. The middle vertical member 44 is generally parallel to the pair of side vertical members 20 and 22. The middle vertical member 44 is shown located midway between the lengths of the top and bottom horizontal members 16 and 18 and connected to these two components through the use of a T-fitting and a cross-fitting. However, it is to be understood that the middle vertical member 44 may be integrally formed or may be connected to other components of frame 14 in a number of different manners. The middle vertical member 44 functions to provide structural support to the frame 14. A leg 46 is present and is located at substantially the midpoint of the bottom horizontal member 18. The leg 46 functions to support the bottom horizontal member 18 a distance 34 from the ground 36 as do the other two legs 30 and 32. The leg 46 can be integral with the middle vertical member 44 or as shown may be a separate component that is attached through the use of a cross-fitting to the bottom horizontal member 18. Although shown as including the middle vertical member 44 and leg 46, these elements need not be incorporated into the panel 12 in accordance with other various embodiments.

The middle vertical member 44 includes a handle 48 that assists a user in picking up the panel 12 and transporting the panel 12 to a new desired location. The handle 48 can be variously constructed. For example, the handle 48 may be polyvinyl chloride tubing that is attached to the middle vertical member 44 through the use of a fitting. The handle 48 can be located on a side of the middle vertical member 44 opposite that of the wire member 26 so that these two components do not interfere with one another. The handle 48 need not be present in other versions of panel 12, or handle 48 can be attached to other elements of panel 12.

The panel 12 is shown located next to a second panel 58. In this manner, multiple panels can be located next to one another in order to form an electric fence 10 of a desired size, shape and configuration. The second panel 58 is shown constructed in a manner identical to the panel 12. In this regard, second panel 58 has a second wire member 60, second frame 62 and a second side vertical member 66 that function in a manner as previously described with respect to their counterparts in the panel 12. Panel 12 and the second panel 58 can be placed next to one another so that the frames 14 and 62 are not attached. However, as shown in FIG. 2 the frames 14 and 62 are releasably attached to one another through the use of releasable connections 24.

FIG. 3 shows a cross-sectional view of the releasable connection 24 taken along line 3-3 in FIG. 2. As shown, the releasable connection 24 is a bracket 52 that has a sleeve 54 that fits around both the side vertical member 22 and the second side vertical member 66. The sleeve 54 has a contoured inner surface so that the side vertical member 22 and the second side vertical member 66 can be rotated with respect to one another into a desired orientation. One or more mechanical fasteners 56 can be tightened in order to cause the sleeve 54 to be tightened and hold onto the side vertical member 22 and the second side vertical member 66 in order to hold these components in place with respect to one another. The bracket 52 thus functions to hold the panel 12 and the second panel 58 onto one another in a desired orientation. When the electric fence 10 is to be moved the panel 12 and second panel 58 may be detached from one another by removing the mechanical fasteners 56 to loosen and detach the sleeve 54. The bracket 52 thus functions to render the panel 12 and second panel 58 releasably attachable to one another so that they can be conveniently assembled and disassembled when constructing and moving the electric fence 10. Although a pair of brackets 52 are shown in the exemplary embodiment in FIG. 2, the electric fence 10 may be arranged so that up to ten releasable connections 24/brackets 52 can be employed to effect releasable connection.

The releasable connection 24 allows the panels 12 and 58 of the electric fence 10 to be quickly and easily secured to and removed from one another. This allows the electric fence 10 to be quickly and easily assembled and disassembled in various locations to allow for rotational grazing and other enclosing of livestock 38 as desired. As such, the electric fence 10 is a portable electric fence 10 in that it can it includes panels 12 and 58 that can be releasably attached to one another. However, it is to be understood that other arrangements are possible in which the panels 12 and 58 of the electric fence 10 are permanently attached to one another or are arranged next to one another so that they are not attached to one another when assembled but instead simply remain positioned adjacent one another.

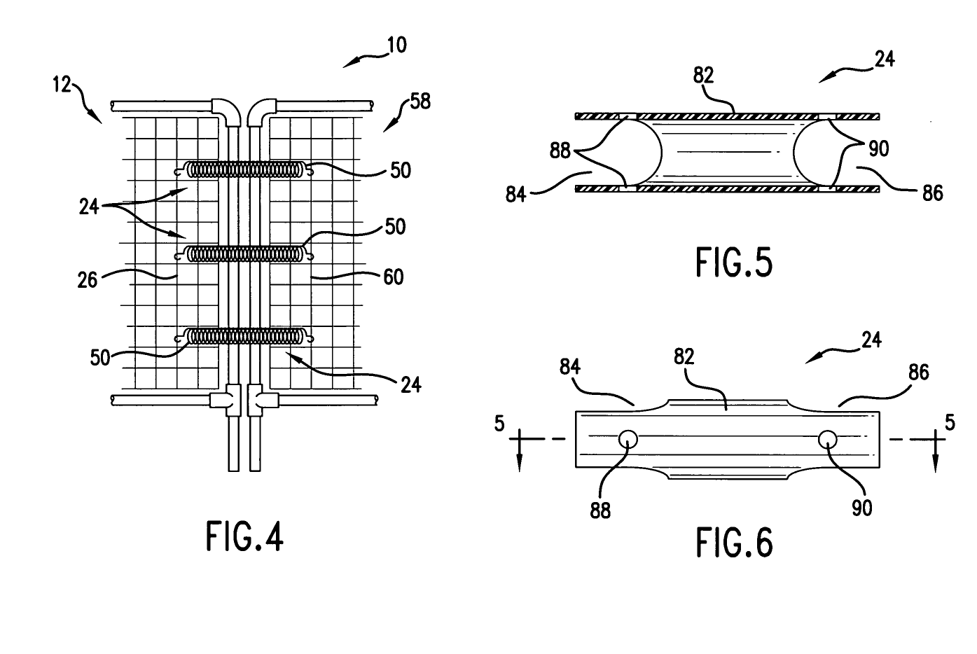

FIG. 4 shows a detailed front view of the panel 12 and the second panel 58 in accordance with another exemplary embodiment of the electric fence 10. Here, the releasable connection 24 is a coil spring 50. The coil spring 50 is hooked onto the wire member 26 of the panel 12 on one end and is hooked on an opposite end to the second wire member 60 of the second panel 58. The coil spring 50 functions to pull the two panels 12 and 58 towards one another and hence effects an attachment to position the panels 12 and 58 in a desired location. The coil spring 50 is also electrically conductive. This feature is beneficial in that electricity passing through the wire member 26 can be conducted through the coil spring 50 and into the second wire member 60. The coil spring 50 thus functions to both attach the panels 12 and 58 and to conduct electricity between the two. In other embodiments in which the releasable connection 24 is non-conductive one or more jumper wires may be used in order to transfer electricity between the panel 12 and second panel 58. Although shown as employing three coil springs 50, up to ten coil springs 50 may be used as the releasable connection 24 in accordance with other exemplary embodiments. The coil spring 50 can be unhooked from either the wire member 26 or the second wire member 60 when the panels 12 and 58 are desired to be disassembled.

Another version of the releasable connection 24 is shown in FIGS. 5 and 6. Here, the releasable connection 24 is a sleeve 82. The sleeve 82 is a tubular member and can be made of polyvinyl chloride tubing. The sleeve 82 may be selected so that its outer and inner diameter are both larger than the outer and inner diameters of the side vertical members 22 and 66 of adjacent panels 12 and 58. The sleeve 82 defines a cut-out portion 84 on one end and a cut-out portion 86 on an opposite end. The cut-out portions 84 and 86 are configured so that some of the tubular wall of sleeve 82 is removed while other portions of the tubular wall are left in place. A pair of aligned apertures 88 are defined through the tubular wall of the sleeve 82 proximate to the cut-out portion 84. Similarly, a pair of aligned apertures 90 are defined through the tubular wall of sleeve 82 at a location proximate to the cut-out portion 86. Although shown as a tubular member, it is to be understood that the sleeve 82 may be a solid piece or may be variously configured in accordance with other exemplary embodiments. Further, the sleeve 82 may be made of a variety of materials and need not be made of polyvinyl chloride in other versions.

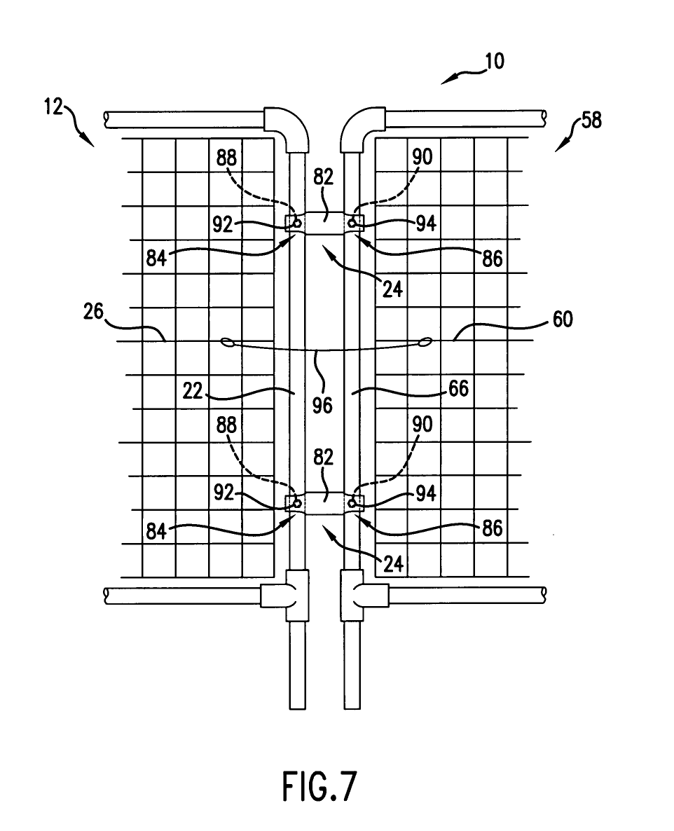

FIG. 7 shows the sleeve 82 placed into use in order to physically connect the panel 12 and the second panel 58. The sleeve 82 is positioned so that the side vertical member 22 is located inside of the cut-out portion 84. As stated, the tube making up the sleeve 82 is larger than the tube making up the side vertical member 22 thus allowing the sleeve 82 to fit over the side vertical member 22. The aligned apertures 88 are placed into alignment with a hole, slot or other aperture defined through the side vertical member 22. A bolt 92 is placed through the aligned apertures 88 and the side vertical member 22 in order to retain the sleeve 82 onto the side vertical member 22. In a similar manner, the cut-out portion 86 of the sleeve 82 is placed over the second side vertical member 66 of the second panel 58. The tube making up the sleeve 82 is larger than the tube making up the side vertical member 66 thus allowing the aforementioned overlapping arrangement. The aligned apertures 90 of the sleeve 82 are placed into alignment with holes, slots or other features of the second side vertical member 66. A bolt 94 is placed through the aligned apertures 90 and the second side vertical member 66 in order to retain the sleeve 82 to the second side vertical member 66. As shown, the sleeve 82 thus functions to physically hold the vertical members 22 and 66 to one another and therefore physically hold the panel 12 to the second panel 58. The user may loosen and remove the bolts 92 and 94 in order to disengage the sleeve 82 when it is desired to disconnect the panel 12 and second panel 58 from one another. In this manner, the sleeve 82 is a releasable connection because the bolts 92 and 94 can be quickly and easily disengaged and engaged from and to one another.

A pair of sleeves 82 are shown in FIG. 7. Both of the sleeves 82 can be arranged in the same manner. As shown, one of the sleeves 82 is located at the top of the vertical members 22 and 66 and the other sleeve is located at the bottom of the vertical members 22 and 66. However, it is to be understood that any number of sleeves 82 may be used in accordance with other exemplary embodiments. For example, up to seven sleeves 82 may be used in order to effect a releasable connection 24 in certain embodiments. Also, although shown as allowing for a limited orientation between the vertical members 22 and 66, other releasable connections 24 are possible in which a variety of orientations can be achieved between the vertical members 22 and 66 so that the panel 12 and second panel 58 can be arranged in a variety of rotational angles with respect to one another. As shown, a jumper line 96 is present in order to place the wire member 26 and second wire member 60 in electrical communication with one another. The jumper line 96 is electrically conductive and tied onto the wire mesh making up the wire members 26 and 60.

The electric fence 10 can be variously configured in accordance with other exemplary embodiments. Referring back to FIG. 1, a number of panels are shown in construction of the electric fence 10. A third panel 74 is shown releasably attached to the second panel 58. The third panel 74 is different than panels 12 and 58 in that the leg 46 is not present and that legs 30 and 32 are not located immediately beneath the side vertical members 20 and 22. In this regard, the legs 30 and 32 of third panel 74 are positioned inward of the side vertical members 20 and 22 an equal distance.

A fourth panel 76 shown in FIG. 1 is adjacent the third panel 74 and is releasably attached to the third panel 74 with a releasable connection 24. The fourth panel 76 includes an angled section 70 that is attached to both the top horizontal member 16 and to the side vertical member 20. Additionally, another angled section 72 is included and is attached to the top horizontal member 16 and to the side vertical member 22. The angled sections 70 and 72 act to strengthen the resulting frame 14. In other embodiments the angled sections 70 and 72 may be attached to the bottom horizontal member 18 instead of to the top horizontal member 16. In yet other embodiments, four angled sections 70 and 72 may be included so that they are attached proximate to the four courners of the frame 14. The fourth panel 76 is releasably attached to a fifth panel 78. The releasable connection 24 employed to effect this attachment is a rope 68 that is tied onto the side vertical members 20 and 22. Releasable attachment of the various panels causes them to remain upright of their own accord such that the legs 30 and 32 of the various panels 12 do not have to be driven into the ground 36 of the pasture. This functionality saves one time during construction of the portable electric fence 10 in that none of the panels 12 have to be driven into ground 36 that may be hard and thus difficult to insert. However, it is to be understood that other arrangements are possible in which one or more of the panels 12 are driven into the ground 36. Also, it is to be understood that the various releasable connections 24 shown are only certain examples and that others may be used to effect releasable connection between the panels 12 of the electric fence 10 in other embodiments.

The fifth panel 78 includes a wire member 26 that is composed of three wires that are parallel to one another and extend in the horizontal direction between the side vertical members 20 and 22. The wires of the wire member 26 are attached to the side vertical members 20 and 22 and are not attached to the top and bottom horizontal members 16 and 18. In alternative arrangements the wire member 26 can be a single integral piece that is carried on the frame 14 or may be made of one or more pieces that are not integral with one another and carried on the frame 14. As such, the wire member 26 may be variously arranged in accordance with different exemplary embodiments and it is to be understood that the variations shown are only for sake of example. The wire members 26 of adjacent panels 12 can be placed into electrical communication through jumper wires that are attached to the adjacent wire members 26. Additionally or alternatively, electrical communication between adjacent wire members 26 can be achieved through the releasable connections 24 that effect their attachment. All or fewer than all of the wire members 26 of the various panels 12 may conduct electricity and hence be capable of shocking livestock 38 in various arrangements of the electric fence 10.

The various panels of the electric fence 10 as shown in FIG. 1 have different features for sake of illustrating various constructions. In accordance with other embodiments it is to be understood that all of the panels of electric fence 10 may be constructed in an identical or substantially similar manner. Further, other panels, such as a gate panel, may be incorporated into the electric fence 10 that may or may not include a wire member 26 that is electrified.

It is to be understood that the electric fence 10 can be used in a variety of applications. Although described as being used for rotational grazing, the electric fence 10 could alternatively or additionally be used for segregating livestock 38. In this regard, it may be desirable to separate certain livestock 38 from one another without regard to any use of the electric fence 10 for rotational grazing purposes. As such, the uses of the electric fence 10 as discussed herein are only exemplary and it is to be understood that the electric fence 10 can be used in a variety of applications for a variety of purposes.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

What is claimed:

1. An electric fence, comprising:
a plurality of panels releasably connected to one another to form at least a partial enclosure, wherein each of said panels has a frame that includes a top horizontal member and a bottom horizontal member and two side vertical members, wherein said panels are arranged side by side such that said vertical members of adjacent said panels are releasably connected to one another, wherein said frame carries a wire member that is electrically conductive for use in delivering an electrical shock to livestock that comes into contact with said wire member.

2. The electric fence as set forth in claim 1, wherein said wire member is a mesh that covers an area defined by said top horizontal member, said bottom horizontal member and said two side vertical members.

3. The electric fence as set forth in claim 1, wherein said frame has at least two legs that suspend said bottom horizontal member at least one foot off of the ground.

4. The electric fence as set forth in claim 3, wherein the length of said two vertical side members is at least four times the length of said two legs.

5. The electric fence as set forth in claim 1, wherein said wire member is attached to said top horizontal member with an electrically conductive upper attachment member, and wherein said wire member is attached to said bottom horizontal member with an electrically conductive lower attachment member.

6. The electric fence as set forth in claim 1, wherein said frame has a middle vertical member that is located halfway between said two side vertical members, wherein said middle vertical member is attached to said top horizontal member and to said bottom horizontal member, and wherein said middle vertical member has a handle located thereon for use in moving said panel to a different location.

7. The electric fence as set forth in claim 1, wherein said wire members of adjacently disposed panels are placed into electrical communication with one another by a coil spring attached to both of said wire members of said adjacently disposed panels, and wherein said coil springs function to place said adjacently disposed panels into releasable connection with one another.

8. The electric fence as set forth in claim 1, wherein said top horizontal member, said bottom horizontal member and said two side vertical members are nonconductive and are made of polyvinyl chloride tubing.

9. The electric fence as set forth in claim 1, wherein said vertical members of adjacent said panels are releasably connected to one another by brackets that are tightened and held in place by mechanical fasteners.

10. A panel for use in an electric fence, comprising:
a frame made of a generally nonconductive material; and
a wire member carried by said frame and configured for conducting electricity therethrough for use in delivering an electric shock to livestock that comes into contact with said wire member, wherein said wire member is configured for being in electrical communication with a second wire member of an adjacent second panel such that electricity is capable of being conducted through said wire member and into the second wire member.

11. The panel as set forth in claim 10, wherein said frame has a plurality of legs configured for contacting the ground of a pasture such that said legs are capable of standing on the ground of a pasture and are not driven into the ground of a pasture, wherein said legs are configured to elevate said wire member at least six inches from the ground of a pasture.

12. The panel as set forth in claim 11, wherein said frame has a top horizontal member and a bottom horizontal member and two side vertical members, and wherein said wire member is attached to said top horizontal member with an electrically conductive upper attachment member that is a wire that is wrapped around said top horizontal member, and wherein said wire member is attached to said bottom horizontal member with an electrically conductive lower attachment member that is a wire that is wrapped around said bottom horizontal member.

13. The panel as set forth in claim 10, wherein said frame is made of polyvinyl chloride tubing.

14. The panel as set forth in claim 10, wherein said wire member is a mesh that spans the distance from one side of said frame to an opposite side of said frame.

15. The panel as set forth in claim 10, wherein said frame has a middle vertical member that is located halfway between opposite sides of said frame, and wherein said middle vertical member has a handle located thereon for use in moving said frame to a different location.

16. The panel as set forth in claim 10, further comprising a coil spring engaging said wire member, wherein said coil spring is configured for engaging the second wire member of the second panel in order to place said wire member into electrical communication with the second wire member and to releasably connect said wire member and the second wire member.

17. The panel as set forth in claim 10, further comprising a sleeve attached to said frame and configured for releasably connecting said frame to a second frame of the second panel.

18. A panel for use in an electric fence, comprising:
a frame having a top horizontal member and a bottom horizontal member and two side vertical members arranged in a generally rectangular shape, wherein said top horizontal member and said bottom horizontal member and said two side vertical members are made of a generally nonconductive material;
a wire member that is a mesh that is carried by said frame, wherein said wire member covers an area defined by said top horizontal member and said bottom horizontal member and said two side vertical members, wherein said wire member is electrically conductive;
at least two legs configured for contacting and resting on the surface of the ground of a pasture and for elevating said frame and said wire member above the surface of the ground of the pasture; and
a releasable connection capable of engaging said frame in order to releasably connect said frame to a second frame of a second panel.

19. The panel as set forth in claim 18, wherein said releasable connection is selected from the group consisting of a rope, a coil spring, a bracket, and a sleeve.

20. The panel as set forth in claim 18, wherein said top horizontal member and said bottom horizontal member and said two side vertical members and said at least two legs are made of polyvinyl chloride tubing, wherein said wire member is attached to said top horizontal member with an electrically conductive upper attachment member that is a wire that is wrapped around said top horizontal member, and wherein said wire member is attached to said bottom horizontal member with an electrically conductive lower attachment member that is a wire that is wrapped around said bottom horizontal member.
